(19) United States
(12) Patent Application Publication
(10) Pub. No.: US 2024/0079543 A1
(43) Pub. Date: Mar. 7, 2024

(54) Superficial fluorination with elemental fluorine of lithium metal used as anode in lithium metal batteries

(71) Applicant: Politecnico di Milano, Milano MI (IT)

(72) Inventors: Maurizio SANSOTERA, Magenta MI (IT); Luca MAGAGNIN, Rho MI (IT); Eugenio GIBERTINI, Cusago MI (IT); Piergiorgio MARZIANI, Roseto degli Abruzzi TE (IT); Walter NAVARRINI, Boffalora sopra Ticino MI (IT)

(21) Appl. No.: 18/271,275

(22) PCT Filed: Jan. 11, 2022
(86) PCT No.: PCT/IB2022/050172

§ 371 Date: Jul. 7, 2023

(30) Foreign Application Priority Data
Jan. 15, 2021 (IT) 102021000000704

(51) Int. Cl. H01M 4/04; H01M 4/36; H01M 4/38; H01M 4/58

(52) U.S. Cl. CPC H01M 4/0402; H01M 4/366; H01M 4/382; H01M 4/582; H01M 2004/027

(57) ABSTRACT

Surface fluorination process of lithium metal using elemental fluorine. Thereby, a uniform surface layer of LiF free of impurities is formed over the entire surface of the Li metal. This highly reproducible treatment can also be carried out on a large scale, making it possible to obtain a material which can be advantageously used as an anode in a lithium battery, since it ensures significantly higher performance than those obtained not only by using lithium metal as an anode, but also lithium metal anodes provided with a LiF layer, in which the formation of the LiF layer is formed in situ by organic or inorganic fluorine agents.

### FIELD OF THE INVENTION

The present invention relates to a surface fluorination process with elemental fluorine of lithium metal for use as an anode in lithium metal batteries.

### PRIOR ART

Lithium metal batteries (LMBs) can be classified into primary or secondary batteries depending on whether or not they are rechargeable.

Primary LMBs with high energy density were conceived in the 1970s and were used in watches, computers and portable medical devices.

Generally, the energy density of secondary batteries is lower than primary batteries. However, secondary batteries have wider application as they are repeatedly rechargeable.

The first LMBs designed by Nobel laureate Stanley Wittingham at Esso used Li metal as the negative electrode, and TiS₂ as the positive electrode. This research suffered a downturn until the 1980s due to the danger posed by the formation of dendrites on the surface of the lithium anode. Towards the end of the 1970s, Li-ion batteries (LIB), also called “rocking chair” batteries, were studied, which include a series of stratified and interleaved materials for both the anode and the cathode. Based on the charge-discharge theory, lithium ions are transferred from the cathode to the anode without being reduced to lithium metal atoms during charging thus avoiding the formation of dendrites.

In 1991, LIBs appeared on the market for the first time, revolutionising and simultaneously promoting the expansion of the electronics market.

The LIBs which gave the best performance are those in which the anode is made of graphite. However, the energy density of such batteries has reached the limit and cannot be further enhanced, thus to obtain batteries with higher energy densities the research has returned to focus on LMBs.

The aggressive chemistry of lithium metal has given rise to several problems, among which one of the most pressing problems is the formation of lithium dendrites, which causes serious safety risks and is due to the inherent properties of the lithium atom, i.e., the high diffusion barrier of the lithium atom. In fact, the dendrites tend to form both on the holes forming the metal sheet during the initial stripping and on the surface of the Li anode in the initial plating step, when lithium metal is deposited on the anode.

Repeated plating and stripping steps, in other words lithium metal deposition and Li ion dissolution, result in the formation of a large number of dendrites on the anode surface and low coulombic efficiency (CE).

The continuous growth of Li dendrites can lead to penetration and damage of the separator and cause short circuit in the battery, producing a high current discharge accompanied by high heat development and even explosion.

Furthermore, the rapid and irregular dissolution of lithium dendrites near the active site separates the dendritic lithium from the metal matrix producing the so-called “dead Li” or electrically isolated lithium metal which, during the repeated volume changes of the electrolyte, remains wrapped in a thick layer of SEI (solid-electrolyte interface), comprising organic and inorganic Li-based species, which make it inactive. This results in a loss of active lithium in the electrode and therefore in a reduced battery capacity.

Lithium fluoride in the SEI layer has been shown to be a key component in preventing the formation and growth of dendrites in LMBs, since the Li⁺ ion shows a higher diffusion rate through LiF than through Li₂(CO₃)₂, since the barrier energy of the former is 0.09V lower with respect to that of the latter.

There are many methods for obtaining this layer of LiF both by applying an already formed layer of LiF and by in situ formation of lithium fluoride.

Among those of the first type, for example, the method proposed by Peng et al. in which a layer enriched in LiF was applied on the anode, which included nanometre-sized cross-linked LiF domains, which prevents the collateral reactions between the Li metal and the electrolyte resulting in a long-term cycling of the Lithium metal anode.

Another method of the first type was proposed by Hou et al. which envisaged the application of an artificial SEI layer enriched in LiF and Li₃N on the Li anode, able to stabilize the lithium metal and the electrolytes, thus enhancing the compatibility at the interface on the lithium metal anode.

A method of obtaining LiF of the second type was proposed by Lang et. al. by in situ reaction between the lithium metal and a solution of polyvinylidene fluoride (PVDF) in dimethylformamide (DMF), to manufacture an anode coated with a layer of LiF. This SEI film is able to suppress the formation of dendrites and reduce the collateral reactions between lithium metal and carbonate-based electrolyte (see review by R. Wang et al. Journal of Energy Chemistry 48 (2020) 145-159; https://doi.org/10.1016/j.jechem.2019.12.024).

There is also a method of the first type by which a layer of LiF is applied for chemical vapour deposition (CVD) (J. Koh et al. Thin Solid Films 119-125; https://doi.org/10.10161j.tsf.2019.01.48).

Most of the methods of the second type by formation of LiF on the anode by chemical reaction contemplate indirect fluorination by decomposition of a fluorinated organic compound such as that of Lang et al., mentioned in the aforementioned review of Wang et al., allowing the formation of LiF, but also of further layers of carbon compounds of various types. In any case, these processes are difficult to scale, because they also require very high temperatures and do not always give reproducible results.

For example, S. Sun et al. disclose a protective SEI layer formed by a composite LiF/defluorinated polymer material, uniformly deposited on lithium metal by roller pressing on PTFE Li as a sacrificial layer. The SEI layer formed with this process is thus made up of an innermost layer in contact with the lithium-enriched lithium metal, while the outermost layer on the electrolyte side consists of a polymeric material consisting of a mixture of a polyene and an unsaturated fluoropolymer (S. Sun et al. J. Mater. Chem. A 2020, 8, 17729-17237; DOI:10139/d0ta05372d).

D. Lin et al. instead disclosed a process of forming a protective layer of LiF by treatment with Freon gas R134A (1,1,2,2 tetrafluoroethane) and Li metal at temperatures not below 150° C. First (CH₂F—CF₂)⁻Li⁺ is formed, then by α or by β elimination LiF is obtained. In any case, additional and rather complex by-products are formed. To reduce the quantity of these by-products the work must be performed at 180° C. (D. Lin et al., Nano letters 2017, 17, 3731-3737; DOI: 10,121/acs.nanolett7b0120).

Zhao et al. instead thought of using, as a source of fluorine to form the layer of LiF on the anode, the fluorinated polymer CYTOP which, degrading at T of 350° C. releases the fluorine which, coming into contact with the Li anode, forms a coating of LiF thereon (J. Zhao et al. J. Am. Chem. Soc. 2017, 139, 11550-11558.DOI:10.1021/Jacs.7b05251).

A further method for forming the coating of Li fluoride on the anode described by He et al includes as a fluorinating agent instead of an organic fluorinating agent, an inorganic fluorinating agent such as nitrogen trifluoride NF₃. Also in this case, to obtain a uniform layer of LiF it is necessary to operate at high temperatures not less than 180° C. and in any case the LiF layer is not sufficiently resistant because during the plating step it is subject to such and many morphological changes, to no longer distinguish from the lithium metal and this occurs already after being subjected to 1.5 cycles. (M. He et al, PNAS/Jan. 7, 2020/10 vol. 117/no.1/7 3-79. www.pnas.org/cgi/doi/10.1073/pnas.1911017116)

### SUMMARY OF THE INVENTION

The applicant has instead found a safe surface fluorination process of lithium metal, with which it is possible to obtain a uniform layer on the lithium anode, by virtue of which the lithium anode can be subjected to countless cycles.

This process is also easily scalable, transformable and even continuously operable if the operating conditions are appropriately modulated. Furthermore, unlike the aforementioned treatments obtained by in-situ production of fluorine gas, the process proposed by the present invention does not involve the emission of by-products given by the decomposition of the precursors, by virtue of the use of fluorine gas. Furthermore, fluorine gas is already widely used industrially in the fluorinated materials industry.

In particular, the process comprises fluorination with fluorine gas on the surface of lithium metal at a pressure between 0.01 mbar and 10 bar and at temperatures between −78 and 180° C.

An inert diluent gas can be used together with fluorine under reaction conditions with a pressure between 0.01 mbar and 10 bar. Inert gases under the reaction conditions can be for example: noble gases, in particular He or Ar, perfluoroalkanes, such as CF₄ or C₂F₆, or fluorinated inert gases, such as sulphur hexafluoride, SF₆. With this methodology it is possible to flow the gaseous mixture containing the fluorine (pure or diluted) into the fluorination reactor with a flow rate between 0.05 and 100 NL/h. However, those skilled in the art can suitably choose the diluent gas as a function of the operating conditions so that it does not interfere with the surface fluorination process.

A further object of the present invention is an Li metal anode for lithium metal batteries (LMB) surface coated with a LiF-based layer, in which said layer essentially consists of LiF, and is preferably obtained by the process according to the present invention.

Finally, a further object of the present invention is a Li metal battery (LMB) comprising the anode object of the present invention.

### DESCRIPTION OF THE FIGURES

FIG. 1 describes the trend of potential over time of the surface LiF-coated lithium metal cyclate anode according to the methods described in example 1.

FIG. 2 shows the electrochemical impedance spectrogram of said LiF-coated anode according to the operating conditions of example 1 before and after being cycled.

FIG. 3 describes the trend of potential over time of the surface LiF-coated lithium metal cyclate anode according to the methods described in example 2.

FIG. 4 describes the trend of potential over time of the surface LiF-coated lithium metal cyclate anode according to the methods described in example 3.

FIG. 5 describes the trend of potential over time of the surface LiF-coated lithium metal cyclate anode according to the methods described in example 4.

FIG. 6 describes the trend of potential over time of the surface LiF-coated lithium metal cyclate anode according to the methods described in example 5.

FIG. 7 describes the trend of potential over time of the surface LiF-coated lithium metal cyclate anode according to the methods described in example 6.

FIG. 8 describes the trend of potential over time of the surface LiF-coated lithium metal cyclate anode according to the methods described in example 7.

FIG. 9 describes the trend of potential over time of the surface LiF-coated lithium metal cyclate anode according to the methods described in example 8.

FIG. 10 describes the trend of potential over time of the surface LiF-coated lithium metal cyclate anode according to the methods described in example 9.

FIG. 11 describes the trend of potential over time of the surface LiF-coated lithium metal cyclate anode according to the methods described in example 10.

FIG. 12 describes the trend of potential over time of the surface LiF-coated lithium metal cyclate anode according to the methods described in example 11.

FIG. 13 describes the trend of potential over time of the surface LiF-coated lithium metal cyclate anode according to the methods described in example 12.

FIG. 14 shows the trend of potential over time of the surface LiF-coated lithium metal anode according to the methods reported in example 13 and cycled in a complete cell with LFP cathode.

FIG. 15 shows the specific charge and discharge capacity and coulombic efficiency over time as a function of the time of the surface LiF-coated lithium metal anode according to the methods shown in example 13 and cycled in the complete cell with LFP cathode.

### DETAILED DESCRIPTION OF THE INVENTION

For the purposes of the present invention, the definition “process comprising” does not exclude the presence of additional steps beyond the step expressly mentioned after such a definition.

The definition “process consisting of” means that such a process excludes the presence of further steps beyond that expressly reported after such a definition.

Preferably the process of the invention consists of said surface treatment with pure or diluted fluorine gas with inert gas.

Layer “essentially made of LiF” of the anode according to the present invention means that said layer contains LiF in quantities greater than 92% by weight, preferably in quantities greater than 95%, even more preferably in quantities greater than 98% by weight.

The anode object of the present invention is preferably obtained with the process according to the present invention.

The process according to the present invention is preferably carried out at temperatures between −30 and 130° C. and more preferably between 0 and 90° C., even more preferably between 15 and 80° C.

The pressures are preferably between 0.01 and 1000 mbar, more preferably between 0.5 and 200 mbar.

The amount of fluorine to be added in the process of the invention is preferably between 2.5*10⁻⁹ and 0.51 moles of fluorine/cm² of lithium metal, more preferably between 5.08*10⁻⁹ and 0.255 moles of fluorine/cm² of lithium metal.

With the process of the invention, it is possible to obtain an LiF-coated anode in very short times ranging from 1 second to 40 minutes and preferably between 1 and 30 minutes.

The anode obtained by the process of the invention is very stable and resists for many cycles, for example over 2,000 cycles of stripping and plating.

Precisely for this reason, the batteries of the present invention, which contain such anodes, can be advantageously used in the automotive industry, as in other energy storage applications from small to large scale.

In the batteries forming a further object according to the present invention, the choice of the electrolyte is not critical. In fact, solvents belonging, but not limited to, the family of cyclic and linear carbonates (dimethyl carbonate, ethylene carbonate, propylene carbonate, diethyl carbonate, etc.), ethers (glyme, dioxolane (DOL), dimethyl ether (DME), polyethylene glycol, polyethylene oxide, tetrahydrofuran, etc.), sulfoxides (for example dimethylsulfoxide (DMSO), etc.), ionic liquids, ionic salts (for example Nafion®, Aquivion®, etc.), polymeric gels, polymers, conductive ceramics (for example Li₂₊₂ₓZn₁₋ₓGeO₄, Lithium lanthanum zirconium oxide (Li₇La₃Zr₂O₁₂), Li₂PO₂N, etc.) can be used. The lithium salt is comprised, but not limited to, among LiClO₄, LiNO₃, LiPF₆, LiFSI, LiTFSI, LiBF₄, LiAsF₆. Preferably an electrolyte consisting of 1M LiPF₆ in diethyl carbonate:ethylene carbonate (1:1 by volume) or 1M LiTFSI in 1,3-dioxolane:1,2-dimethoxyethane (1:1 by volume) with the addition of 1-3% by weight of LiNO₃ is used. However, according to preferred embodiments of the invention, as electrolytes, mixtures of electrolytes obtained by mixing 1M LiPF₆ in diethyl carbonate:ethylene carbonate (1:1 by volume) or 1M LiTFSI in 1,3-dioxolane:1,2-dimethoxyethane (1:1 by volume) with LiNO₃, fluoroethylene carbonate, vinylene carbonate and other stabilizing additives of SEI are used.

The choice of cathode is also not critical for the batteries object of the present invention, so conventional types can be used, the choice comprising but not limited to cathodes such as oxides of transition metals (lithium cobalt oxide, LiNiO₂, lithium nickel cobalt aluminium oxide, lithium manganese oxide, nickel manganese cobalt, lithium titanium oxide, Fe₂O₃, Fe₃O₄, TiO₂, CuO, NiO, MnO₂, SnO₂, etc.), oxides of semiconductors (SiO₂, Al₂O₃, etc.), fluorides of transition metals (FeF₂, FeF₃, CoF₃, CuF₂, NiF₂, BiF₃, etc.), transition metal chlorides (FeCl₃, FeCl₂, NiCl₂, CoCl₂, NiCl₂, CuCl₂, AgCl₂, AgCl, etc.), transition metal sulphides (Ni₃S₂, FeS₂, CoS₂, TiS₂, TiS₃, CuS, Cu₂S, VS₂, etc.), sulphur (S), any combination of carbon-sulphur (CS), fluorinated carbon (CₓF_{y}), iodine (I), phosphorus and phosphides of the transition metals (CoP, Ni₂P, WP, MoP, CoP, FeP, Cu₃P, NiP₂, etc.), the carbonaceous metals (Graphene, Graphite, Nanoplatelets, Carbon Black, Acetylene Black, Ketjen Black, Multi Walled Carbon Nanotubes, Single Walled Carbon Nanotubes, Carbon Nanofibers, etc.), the phosphates (LMP, LFP, LCP, LiFeSO₄F, LiVPO₄F, etc.), the transition metals (Ti, V, Cr, Mn, Fe, Co, Ni, Cu, Zn, Zr, Nb, Mo, Tc, Ru, Rh, Pd, Ag, Cd, Hf, Ta, W, Re, Os, Ir, Pt, Au, Hg, Rf, db, Sg, Bh, Hs, Mt, Ds, Rg, Cn, etc.), SOCl₂, SO₂Cl₂, SO₂, Ag₂CrO₄, silver vanadium oxides (SVO), copper oxyphosphate, PbCuS, bismuth lead, selenium, air. Preferably a prelitiate cathode is used such as lithium iron phosphate (LFP), lithium cobalt oxide (LCO), lithium manganese oxide (LiMn₂O₄), lithium cobalt oxide containing nickel, manganese and aluminium (NMC, NCA). Some examples of patents in which the aforementioned cathodes are used are EP2983230A1, U.S. Pat. No. 9,755,234B2, U.S. Pat. No. 7,722,848B2, U.S. Pat. No. 6,103,213A, WO2016106321A1, WO2007034243A1.

The following examples are also given in the following examples given below for illustrative, non-limiting purposes.

Ex. 1: Fluorination at 100 Mbar for 3 Min at RT (25° C.)

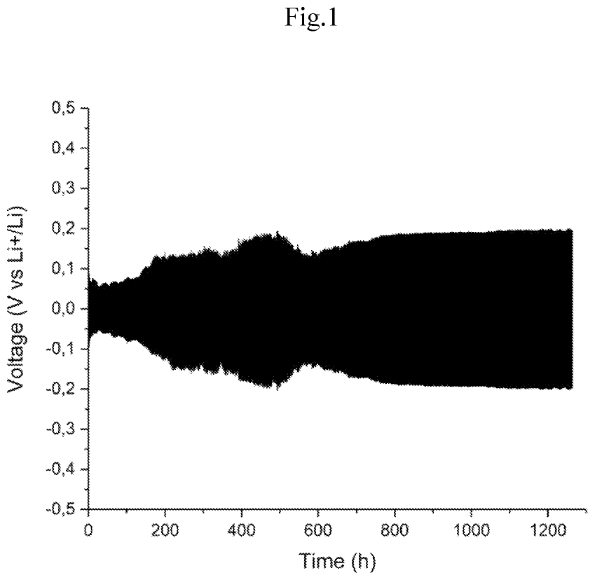

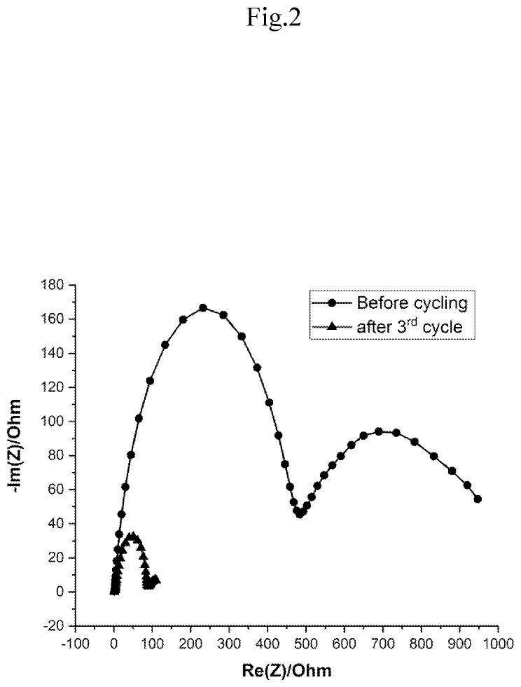

A lithium disc of 1 mm thickness and 15 mm diameter is inserted into the fluorination reactor. Fluorine gas F₂ was injected into the fluorination reactor at a pressure of 100 mbar, at room temperature for 3 min. The thus obtained fluorinated lithium anode was cycled (plating-stripping) at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. FIG. 1 shows the trend of the potential over time. FIG. 2 shows the electrochemical impedance spectrogram before cycling and after 3 cycles.

Ex. 2: Fluorination at 29 Mbar for 3 Min at RT (25° C.) with Pre-Cycles.

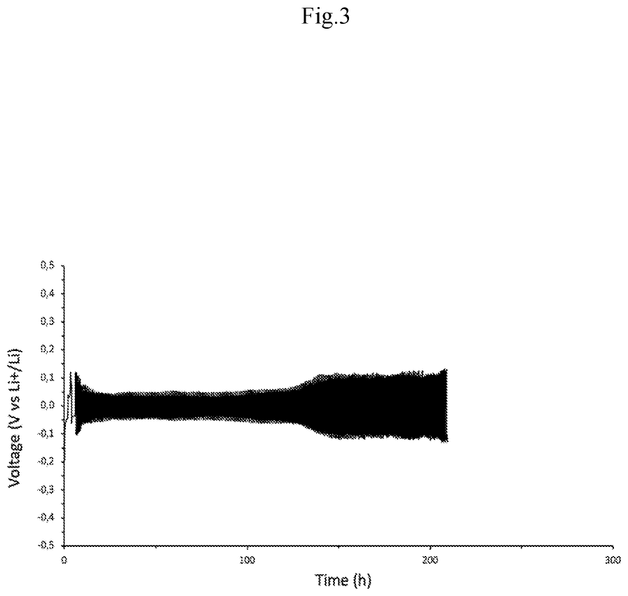

A lithium disc of 1 mm thickness and 15 mm diameter is placed in the fluorination reactor, with reduced volume. Fluorine gas F₂ was injected into the fluorination reactor at a pressure of 29 mbar, at room temperature for 3 min. One of the thus obtained fluorinated lithium anodes was cycled at 0.1 mA/cm² and 0.2 mAh/cm² for 1.5 cycles (plating-stripping-plating) and subsequently at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. The graph related to the trend of the potential over time is shown in FIG. 3.

Ex. 3: Fluorination at 35 Mbar for 3 Min at 80° C. with Pre-Cycles,

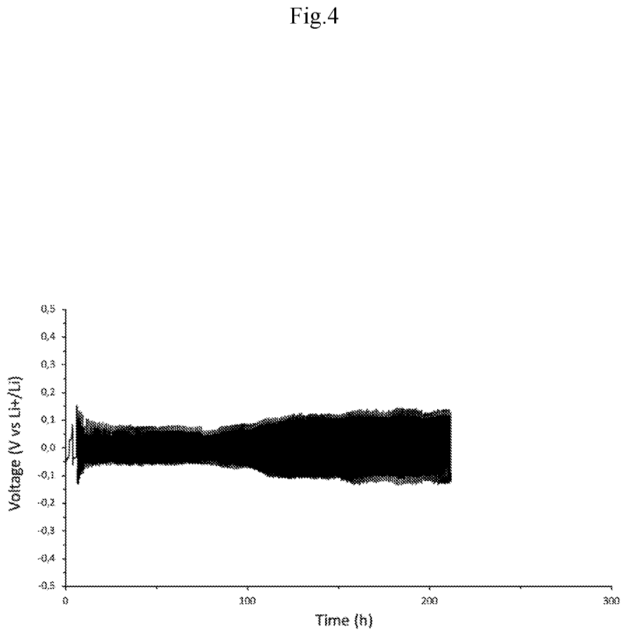

A lithium disc of 1 mm thickness and 15 mm diameter is placed in the fluorination reactor, with reduced volume. Fluorine gas F₂ was injected into the fluorination reactor at a pressure of 35 mbar, at a temperature of 80° C. for 3 min. The thus obtained fluorinated lithium anode was cycled at 0.1 mA/cm² and 0.2 mAh/cm² for 1.5 cycles (plating-stripping-plating) and subsequently at 2 mA/cm² and 1 mAh/cm² using as electrolyte 1M LiTFSI in 1,3-dioxolane:1,2-dimethoxyethane (1:1 by volume) with the addition of 1-3% by weight of LiNO₃. The graph related to the trend of the potential over time is shown in FIG. 4.

Ex. 4: Fluorination at 35 Mbar for 3 Min at 80° C. with Pre-Cycles,

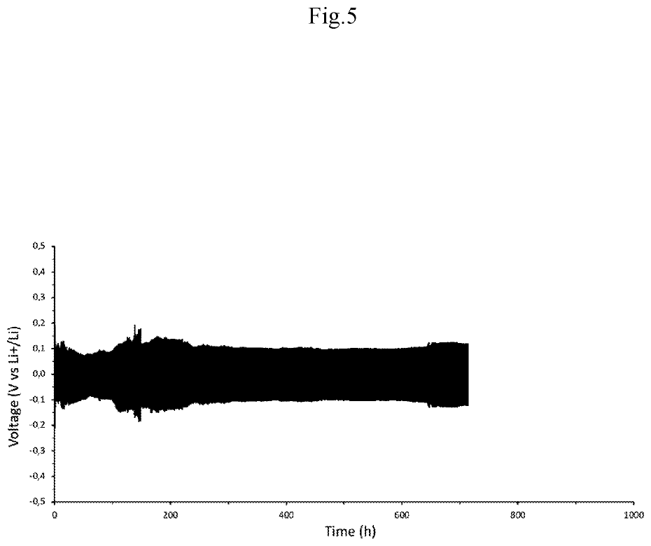

A lithium disc of 200 microns thickness and 15 mm diameter is placed in the fluorination reactor, with reduced volume. Fluorine gas F₂ was injected into the fluorination reactor at a pressure of 35 mbar, at a temperature of 80° C. for 3 min. The thus obtained fluorinated lithium anode was cycled at 0.1 mA/cm² and 0.2 mAh/cm² for 1.5 cycles (plating-stripping-plating) and subsequently at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. The graph related to the trend of the potential is shown in FIG. 5.

Ex. 5: Fluorination at 18 Mbar for 30 Min at RT (25° C.) with Pre-Cycles

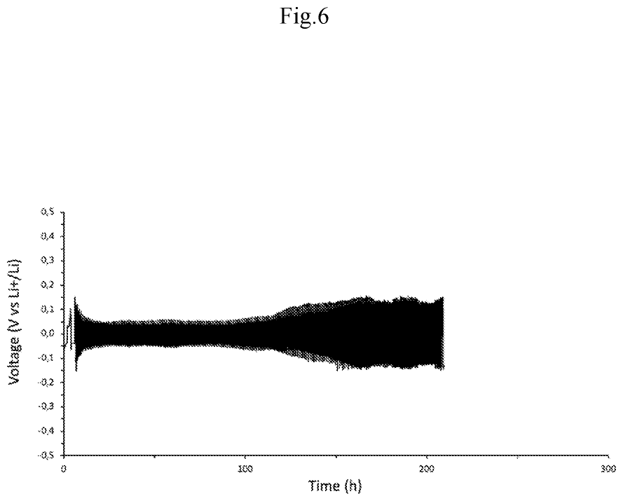

A lithium disc of 1 mm thickness and 15 mm diameter is placed in the fluorination reactor, with reduced volume. Fluorine gas F₂ was injected into the fluorination reactor at a pressure of 6 mbar, at room temperature for 30 min. The thus obtained fluorinated lithium anode was cycled at 0.1 mA/cm² and 0.2 mAh/cm² for 1.5 cycles (plating-stripping-plating) and subsequently at 2 mA/cm² and 1/cm², using as electrolyte 1M LiTFSI in 1,3-dioxolane:1,2-dimethoxyethane (1:1 by volume) with the addition of 1-3% by weight of LiNO₃. The graph related to the trend of the potential over time is shown in FIG. 6.

Ex. 6: Fluorination at 32 Mbar for 3 Min at 50° C. with Pre-Cycles.

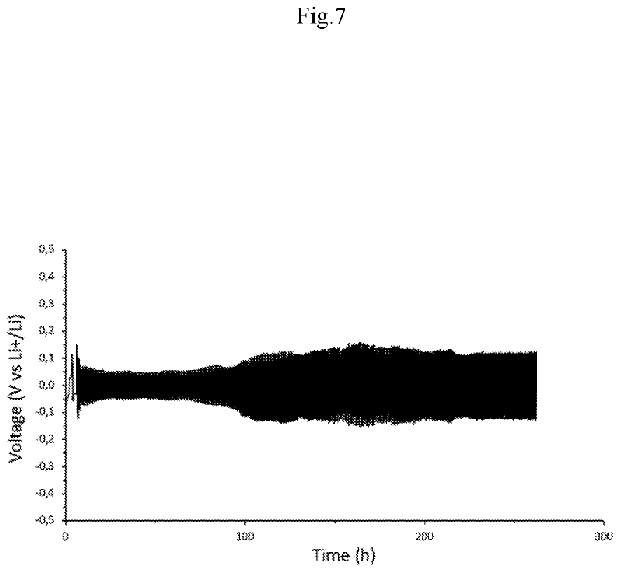

A lithium disc of 1 mm thickness and 15 mm diameter is placed in the fluorination reactor, with reduced volume. Fluorine gas F₂ was injected into the fluorination reactor at a pressure of 32 mbar, at a temperature of 50° C. for 3 min. The thus obtained fluorinated lithium anode was cycled at 0.1 mA/cm² and 0.2 mAh/cm² for 1.5 cycles (plating-stripping-plating) and subsequently at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. The graph related to the trend of the potential over time is shown FIG. 7.

Ex. 7: Fluorination at 6 Mbar for 30 Min at RT (25° C.) with Pre-Cycles.

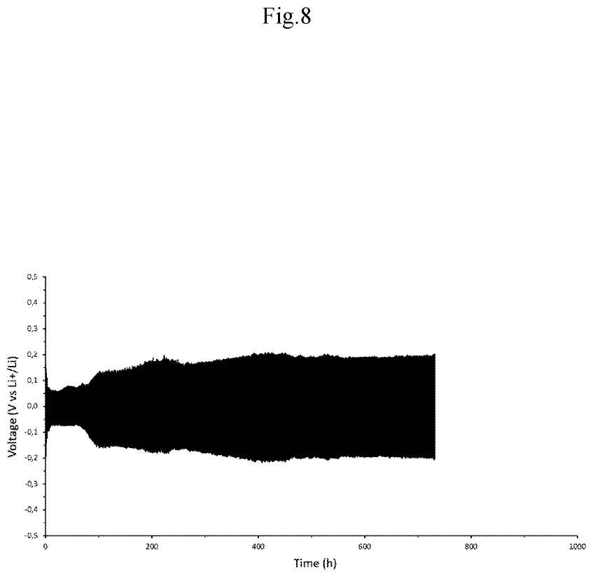

A lithium disc of 200 microns thickness and 15 mm diameter is placed in the fluorination reactor, with reduced volume. Fluorine gas F₂ was injected into the fluorination reactor at a pressure of 6 mbar, at room temperature for 30 min. The thus obtained fluorinated lithium anode was cycled at 0.1 mA/cm² and 0.2 mAh/cm² for 1.5 cycles (plating-stripping-plating) and subsequently at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. The graph related to the trend of the potential over time is shown in FIG. 8.

Ex. 8: Fluorination at 100 Mbar for 10 Min at RT (25° C.) without Pre-Cycles.

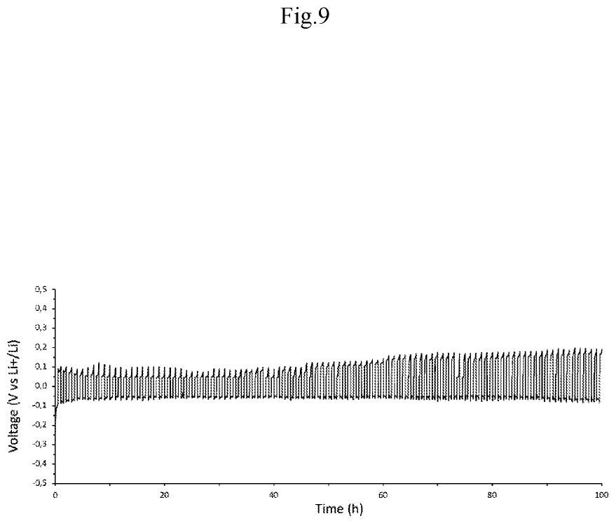

A lithium disc of 1 mm thickness and 15 mm diameter is positioned in the fluorination reactor. Fluorine gas F₂ was injected into the fluorination reactor at a pressure of 100 mbar, at room temperature for 10 min. The thus obtained fluorinated lithium anode was cycled at 1 mA/cm² and 0.5 mAh/cm² for 1.5 cycles (plating-stripping-plating) and subsequently at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. The graph related to the trend of the potential over time is shown in FIG. 9.

Ex. 9: Fluorination at 20 Mbar for 10 Min at RT (25° C.) without Pre-Cycles.

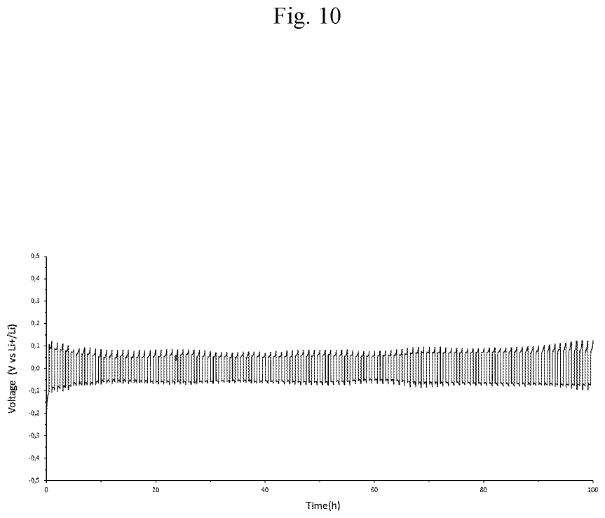

A lithium disc of 1 mm thickness and 15 mm diameter is positioned in the fluorination reactor. Fluorine gas F₂ was injected into the fluorination reactor at a pressure of 20 mbar, at room temperature for 10 min. The thus obtained fluorinated lithium anode was cycled at 1 mA/cm² and 0.5 mAh/cm² for 1.5 cycles (plating-stripping-plating) and subsequently at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. The graph related to the trend of the potential over time is shown in FIG. 10.

Ex. 10 Fluorination at 6 Mbar for 3 Min at RT (25° C.) with Pre-Cycles.

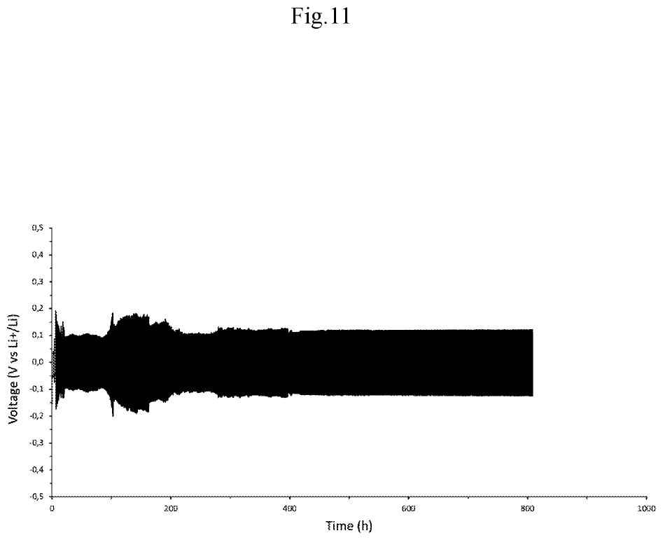

A lithium disc of 1 mm thickness and 15 mm diameter is placed in the fluorination reactor, with reduced volume. Fluorine gas F₂ was injected into the fluorination reactor at a pressure of 6 mbar, at room temperature for 3 min. The thus obtained fluorinated lithium anode was cycled at 0.1 mA/cm² and 0.2 mAh/cm² for 1.5 cycles (plating-stripping-plating) and subsequently at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. The graph relating to the trend of the potential over time is shown in FIG. 11.

Ex. 11: Fluorination at 0.6 Mbar for 3 Min at RT (25° C.) with Pre-Cycles.

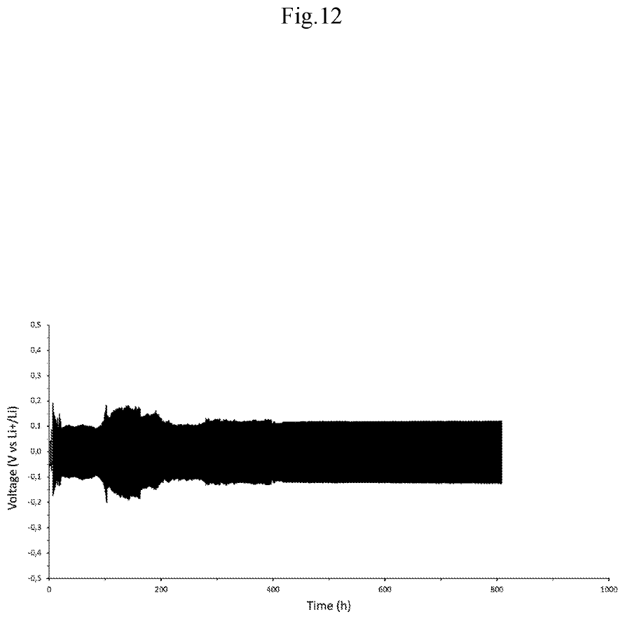

A lithium disc of 1 mm thickness and 15 mm diameter is placed in the fluorination reactor, with reduced volume. Fluorine gas F₂ was injected into the fluorination reactor at a pressure of 0.6 mbar, at room temperature for 3 min. The thus obtained fluorinated lithium anode was cycled at 0.1 mA/cm² and 0.2 mAh/cm² for 1.5 cycles (plating-stripping-plating) and subsequently at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. The graph related to the trend of the potential over time is shown in FIG. 12.

Ex. 12: Fluorination at 6 Mbar for 30 s at RT (25° C.) with Pre-Cycles

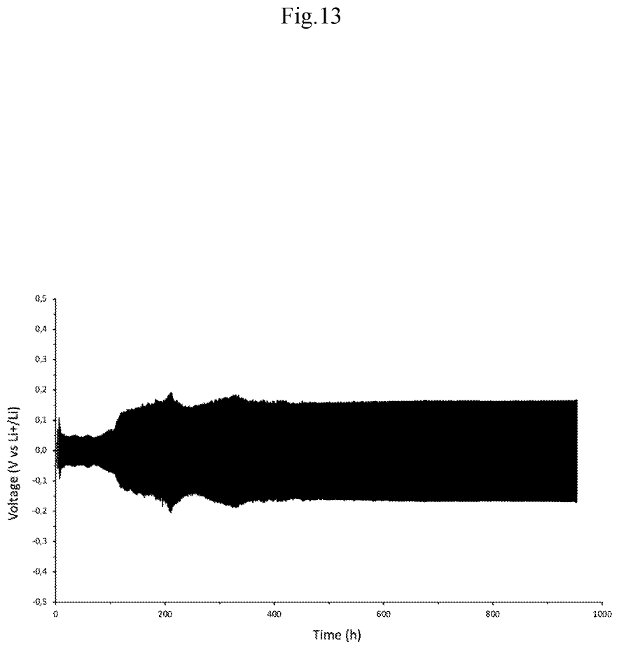

A lithium disc of 1 mm thickness and 15 mm diameter is placed in the fluorination reactor, with reduced volume. Fluorine gas F₂ was injected into the fluorination reactor at a pressure of 6 mbar, at room temperature for 30 s. The thus obtained fluorinated lithium anode was cycled at 0.1 mA/cm² and 0.2 mAh/cm² for 1.5 cycles (plating-stripping-plating) and subsequently at 2 mA/cm² and 1 mAh/cm², using as electrolyte 1M LiTFSI in 1,3-dioxolane:1,2-dimethoxyethane (1:1 by volume) with the addition of 1-3% by weight of LiNO₃. The graph related to the trend of the potential over time is shown in FIG. 13.

Ex. 13: Fluorination at 100 Mbar for 3 Min at RT (25° C.), the Anode Obtained was Used in complete cell with LFP

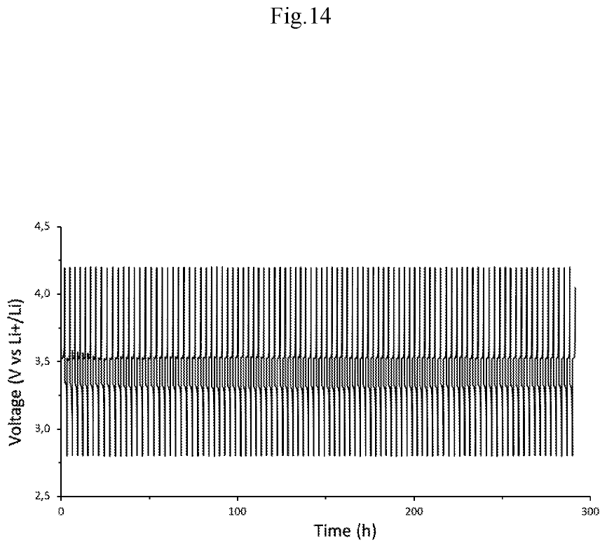

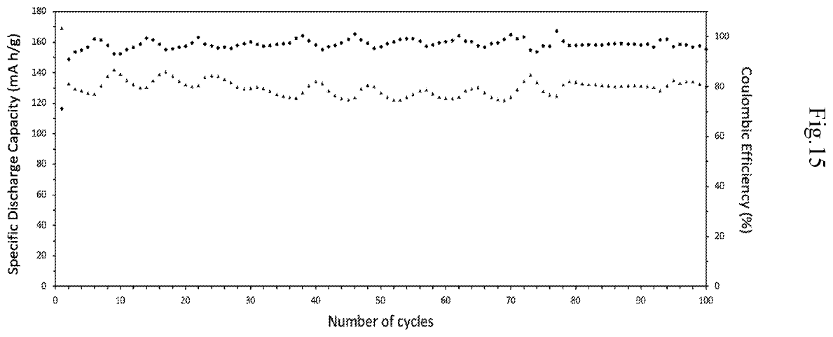

A clean lithium disc of 1 mm thickness and 15 mm diameter is placed in the fluorination reactor, with reduced volume. Fluorine gas F₂ was injected into the fluorination reactor at a pressure of 100 mbar, at room temperature for 3 min. The thus obtained fluorinated lithium anode was cycled at 0.204 mA/cm² in complete cell with a Li Fe phosphate (LFP) based cathode using as electrolyte 1M LiTFSI in 1,3-dioxolane:1,2-dimethoxyethane (1:1 by volume) with the addition of 1-3% by weight of LiNO₃. The graph related to the trend of the potential is shown in FIG. 14 while the specific charging and discharging capacity and coulombic efficiency over time are shown in FIG. 15.

1. Surface coating process of lithium metal with lithium fluoride, comprising treating the lithium metal surface with fluorine gas at a pressure between 0.01 mbar and 10 bar and at temperatures between −78 and 180° C.

2. Process according to claim 1, wherein the lithium metal is treated with a quantity of fluorine gas between 2.5*10⁻⁹ and 0.51 moles of fluorine/cm² of lithium metal.

3. Process according to claim 2, wherein said quantity of fluorine gas is between 5.08*10⁻⁹ and 0.255 moles of fluorine/cm² of lithium metal.

4. Process according to claim 1, wherein the fluorine gas is mixed with an inert gas.

5. Process according to claim 4, wherein said inert gas is selected from He, Ar, perfluoroalkanes, SF₆.

6. Process according to claim 1, wherein the fluorine gas or the mixture of fluorine gas or inert gas is introduced into the reaction environment with a flow rate between 0.05 and 100 NL/h.

7. Process according to claim 1, wherein the temperature is between −30 and 130° C.

8. Process according to claim 7, wherein the temperature is between 0 and 90° C.

9. Process according to claim 8, wherein said temperature is between 15 and 80° C.

10. Process according to claim 1, wherein the pressures are between 0.01 and 1000 mbar.

11. Process according to claim 10, wherein said pressures are between 0.5 and 200 mbar.

12. Process according to claim 1, wherein said lithium metal is treated with fluorine gas for a time between 1 second and 40 minutes.

13. Process according to claim 12, wherein said time is between 1 and 30 minutes.

14. Process according to claim 1, consisting of said surface treatment with fluorine gas.

15. Anode for lithium-metal batteries surface coated with a layer based on LiF, wherein said layer essentially consists of LiF.

16. Anode according to claim 15, wherein the LiF content in said layer is greater than 95%.

17. Anode according to claim 16, wherein the LiF content is greater than 98%.

18. Lithium metal anode surfacely coated with a LiF layer, obtained with the process according to claim 1.

19. Lithium-metal battery containing the anode according to claim 14.
